(19) United States
(12) Patent Application Publication
(10) Pub. No.: US 2010/0092815 A1
(43) Pub. Date: Apr. 15, 2010

(54) MEMBRANE ELECTRODE ASSEMBLY HAVING CATALYST DIFFUSION BARRIER LAYER

(75) Inventors: David A. Condit, Avon, CT (US); Sergei F. Burlatsky, West Hartford, CT (US); Ned E. Cipollini, Enfield, CT (US); Thomas H. Madden, Glastonbury, CT (US); Sathya Motupally, Milford, CT (US)

Correspondence Address: BACHMAN & LAPOINTE, P.C. (UTC), 900 CHAPEL STREET, SUITE 1201, NEW HAVEN, CT, 06510-2802, US

(73) Assignee: UTC POWER CORPORATION, South Windsor, CT (US)

(21) Appl. No.: 12/598,051

(22) PCT Filed: Apr. 30, 2007
(86) PCT No.: PCT/US07/67784

§ 371 Date: Oct. 29, 2009

(51) Int. Cl. H01M 4/86; H01M 4/88

(52) U.S. Cl. 429/13; 429/41; 156/60

(57) ABSTRACT

A membrane electrode assembly includes an anode; a cathode; a membrane between the anode and the cathode and having a thickness defined between the anode and the cathode; and a catalyst diffusion barrier layer in a location bounded on one side by an interface between the membrane and the cathode, and bounded on the other side by a plane approximately 50% of the thickness of the membrane from the cathode. A method of manufacture is also provided.

### BACKGROUND OF THE DISCLOSURE

The disclosure relates to fuel cells and, more particularly, to PEM fuel cells and reduction in degradation of the membrane of same.

In a PEM fuel cell, various mechanisms can cause peroxide to form or exist in the vicinity of the membrane. This peroxide can dissociate into highly reactive free radicals. These free radicals can rapidly degrade the membrane, especially in the presence of certain catalysts. Also, free radicals may form directly on such catalysts through the incomplete reduction of crossover oxygen.

It is desired to achieve 40,000-70,000 hour and 5,000-10,000 hour lifetimes for stationary and transportation PEM fuel cells, respectively. Free radical degradation of the ionomer seriously interferes with efforts to reach these goals.

It is therefore the primary object of the present disclosure to provide a membrane electrode assembly which addresses these issues.

It is a further object of the disclosure to provide a method for operating a fuel cell which further addresses these issues.

A still further object of the disclosure is to provide a method for manufacturing a membrane electrode assembly.

Other objects and advantages appear herein.

### SUMMARY OF THE DISCLOSURE

In accordance with the present disclosure, the foregoing objects and advantages have been attained.

According to the disclosure, a membrane electrode assembly is provided which comprises an anode; a cathode; a membrane between the anode and the cathode and having a thickness defined between the anode and the cathode; and a catalyst diffusion barrier layer in a location bounded on one side by an interface between the membrane and the cathode, and bounded on the other side by a plane approximately 50% of the thickness of the membrane from the cathode.

In further accordance with the disclosure, a method is provided for mitigating decay of a membrane electrode assembly, which method comprises operating a membrane electrode assembly having an anode, a cathode, a membrane between the anode and the cathode, and a catalyst diffusion barrier layer in a location bounded on one side by an interface between the membrane and the cathode, and bounded on the other side by a plane approximately 50% of the thickness of the membrane from the cathode so that the catalyst diffusion barrier layer is between the cathode and a plane of potential change between the anode and the cathode.

A method is also provided for manufacturing a membrane having a desired total thickness and containing a layer at a desired location within the desired total thickness, which method comprises the steps of providing a first membrane component having a first thickness less than the desired total thickness and containing the layer; providing a second membrane component having a second thickness less than the desired total thickness; and laminating the first membrane to the second membrane.

### BRIEF DESCRIPTION OF THE DRAWINGS

A detailed description of preferred embodiments of the present disclosure follows, with reference to the attached drawings, wherein:

FIG. 1 schematically illustrates a membrane electrode assembly including a catalyst diffusion barrier layer in accordance with the present disclosure;

FIG. 2 illustrates catalyst diffusion through a portion of a membrane electrode assembly without a catalyst diffusion barrier layer;

FIG. 3 illustrates an enlarged portion of the assembly of FIG. 1;

FIG. 4 illustrates an enlarged portion of an alternate assembly;

FIG. 5 schematically illustrates a portion of a membrane in accordance with the present disclosures;

FIGS. 6 and 7 schematically illustrate two components of the membrane of FIG. 5; and

FIG. 8 schematically illustrates a laminating process for combining the membrane components of FIGS. 6 and 7 to arrive at the structure of FIG. 5.

### DETAILED DESCRIPTION

The disclosure relates to fuel cells and, more particularly, to polymer electrolyte membrane (PEM) fuel cells, and to mitigating decay or degradation of such fuel cells.

PEM fuel cell durability is often limited by the membrane lifetime of the unitized electrode assembly (UEA) that consists of a three-layer membrane electrode assembly (MEA) and two layers of gas diffusion layers, typically glued or laminated together with a thermo set or thermoplastic edge sealant, respectively. PEM decay occurs from peroxide mediated decay where peroxide is generated by two-electron reduction of oxygen on either the anode or cathode. Peroxide generated on these catalysts can decompose to water and oxygen within the bulk anode or cathode layers, respectively, or it can diffuse into the membrane and be converted to free radicals, particularly in the presence of catalyst such as platinum. Free radicals may form directly on such catalysts through the incomplete reduction of crossover oxygen. These free radicals can attack the membrane ionomer and generate HF polymer fragments as byproducts of the damaged membrane.

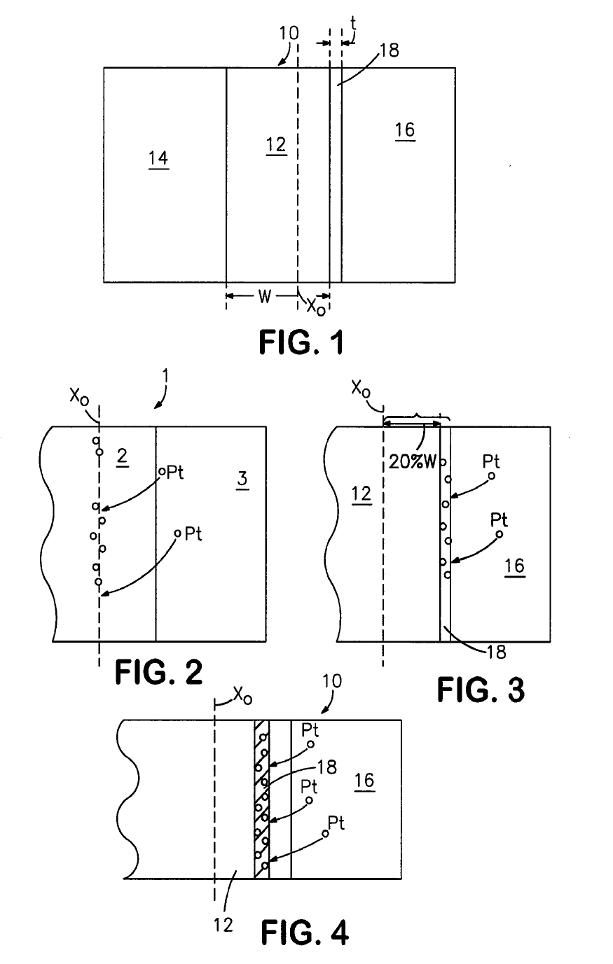

FIG. 1 schematically illustrates a membrane electrode assembly (MEA) 10 in accordance with the disclosure. As shown, assembly 10 includes a membrane 12, an anode 14, a cathode 16, and a catalyst diffusion barrier layer 18. According to the disclosure, layer 18 is a layer which presents a barrier or obstacle to diffusion of soluble catalyst, and layer 18 is positioned between a source of such soluble catalyst, for example cathode 16, and areas of the membrane where soluble catalyst can deposit and cause degradation of the membrane, for example at an inflection plane of the sigmoid potential distribution established by mixed gas concentrations of crossover oxygen and hydrogen. This plane is referred to herein as Xo. The relative position of Xo in FIG. 1 is typical for H2-Air operation. Note that enriching the cathode flow to contain pure oxygen would position Xo towards the mid-plane of the membrane layer 12.

As is well known to a person skilled in the art, membrane electrode assembly 10 is operated by feeding oxygen in some form through a gas diffusion layer to cathode 16 and by feeding hydrogen in some form through a gas diffusion layer to anode 14. These reactants support generation of an ionic current across membrane 12 as desired. During such operation, catalyst from cathode 16 can become soluble and move from cathode 16 toward membrane 12. This soluble catalyst continues to move or migrate into membrane 12 until it reaches Xo, where the soluble catalyst deposits as a narrow band of electrically isolated particles. These particles, unfortunately, serve to mediate the formation of radicals as discussed above which cause membrane degradation. Soluble catalyst deposited at Xo is much more effective for degrading the membrane than when deposited in other locations in membrane 12.

FIG. 2 illustrates this mechanism in a membrane electrode assembly 1 having a membrane 2 and cathode 3. As shown, soluble platinum migrates into membrane 2 and deposits in a band of electrically isolated particles along Xo. If electrically isolated catalyst particles are present at Xo, this is a very likely position for formation of peroxide and/or generation of radicals which can have a deleterious effect upon membrane 12.

According to the present disclosure, layer 18 is adapted and positioned to block this soluble catalyst from reaching Xo.

According to the disclosure, layer 18 serves to restrict diffusion or migration of soluble catalyst. When layer 18 is positioned as set forth herein, soluble catalyst is substantially prevented from reaching Xo, thereby helping to prevent membrane degradation.

One example of a suitable composition for a layer 18 is a reinforcement layer such as those disclosed in U.S. Pat. Nos. 5,795,668, or 6,613,203. These layers are disclosed in those patents as providing mechanical reinforcement to the MEA. According to the present disclosure, the structure of these reinforcement layers has also been found to be an excellent deterrent to diffusion of soluble catalyst.

Layer 18 can be a non-woven, continuous fabric or matt of expanded polytetrafluorethylene, or ePTFE, which can be impregnated with ionomer and can be coated with ionomer on both sides. It is believed that the web structure of such an ePTFE layer helps to intercept and hold soluble catalyst such as soluble platinum, and thereby stop this catalyst from passing through layer 18. Since cathode 16 is a prime source of such soluble catalyst, positioning layer 18 between cathode 16 and Xo serves to slow or prevent the deposit of catalyst particles along Xo. Thus, according to the disclosure, layer 18 can be located at a position bounded on one side by the interface between cathode 16 and membrane 12, and on the other side by a plane which is spaced into membrane 12 a distance which is about 50% of the width of membrane 12, more preferably a distance which is about 20% of the width of the membrane. This serves to locate layer 18 either at Xo, or between cathode 16 and Xo, as desired.

Other types of materials which can be used as layer 18 include materials which have substantially no permeability to soluble catalyst, and which therefore could serve as a barrier or obstacle to soluble catalyst diffusion. Examples of such material include, but are not limited to, inert fiber or particle fillers, hydrocarbon ionomers and the like, preferably which provide a tortuous path to migrating catalyst ions.

The types of ionomer membranes that may be used include both the common class of perflourinated sulfonic acid (PFSA) ionomers, of which Nafion is a common example, or hydrocarbon ionomers.

Ionomers which are perfluorinated can be based upon a variety of main chains, and have fluorine in place of hydrogen. Hydrogen remaining in the main chain of the ionomer leads to attack which is mediated by catalyst metal as described above. Thus, ionomer which is even slightly less than perfluorinated, for example having less than or equal to 99.975% of hydrogen atoms replaced by fluorine, can also benefit from incorporation of layer 18 as discussed above.

As used herein, hydrocarbon ionomers refer collectively to ionomers having a main chain which contains hydrogen and carbon, and which may also contain a small mole fraction of hetero atoms such as oxygen, nitrogen, sulfur, and/or phosphorus. These hydrocarbon ionomers primarily include aromatic and aliphatic ionomers.

Examples of suitable aromatic ionomers include but are not limited to sulfonated polyimides, sulfoalkylated polysulfones, poly(p-phenylene) substituted with sulfophenoxy benzyl groups, and polybenzimidazole ionomers.

Non-limiting examples of suitable aliphatic ionomers are those based upon vinyl polymers, such as cross-linked poly(styrene sulfonic acid), poly(acrylic acid), poly(vinylsulfonic acid), poly (2-acrylamide-2-methylpropanesulfonic acid) and their copolymers.

Ionomers having an inorganic main chain, as used herein, include ionomers based on main chains with inorganic bondings, which can substitute any of a wide range of elements for the carbon. One non-limiting example of such a material is polyphosphazenes composed of N═P bonds. Polyphosphazene derivatives can also be utilized, for example having sulfonic acid, sulfonamide, and/or phosphonic groups.

It should be appreciated that there may be overlap between the above definitions, e.g., many if not all of the hydrocarbon and/or inorganic based ionomers discussed above will also not be perfluorinated. To summarize, the use of barrier layer 18 in the manner described above can apply to any proton conducting ionomer employed in a PEM fuel cell application.

Layer 18 can be a separate layer between membrane 12 and cathode 16, or can be a layer within membrane 12. When a separate layer, layer 18 preferably has a thickness t of between about 1 micron and about 15 microns and when positioned within membrane 12, layer 18 preferably has a thickness t which is between about 25% and about 33% of the total membrane thickness.

FIGS. 1 and 3 show the embodiment wherein layer 18 is positioned between membrane 12 and cathode 16. FIG. 4 shows an embodiment wherein layer 18 is within membrane 12, and in the location defined above between cathode 16 and Xo.

Soluble catalyst ions diffusing through layer 18 will experience a higher potential gradient than they would passing through a like thickness of membrane, and this higher potential gradient will retard movement, perhaps to even promote re-crystallization of the catalyst within layer 18 which further serves to help keep soluble catalyst from reaching Xo.

Soluble catalyst concentrations, when high, can enhance degradation of the membrane. Lower concentrations can be achieved, however, by increasing membrane hydration and/or providing a lower volume % of ionomer in layer 18. This also leads to reduced degradation of membrane 12 according to the disclosure.

Referring back to FIG. 1, anode 14 and cathode 16 can be any typical electrode structure. Thus, cathode 16 can be a porous layer containing a suitable cathode catalyst, for example platinum, and typically having a porosity of at least about 30%. Anode 14 is similarly a porous layer containing suitable anode catalyst, and also typically has a porosity of at least about 30%.

In further accordance with this disclosure, a method is provided for manufacturing a membrane 12 having a layer 18 such as is described above.

If layer 18 is to be positioned at a position directly between membrane 12 and cathode 16, manufacturing methods for positioning this layer in that location are known. If layer 18 is instead to be positioned within membrane 12, for example as is shown in FIG. 4, then positioning of layer 18 within membrane 12 can be problematic.

According to the present disclosure, a method is provided for manufacturing such a membrane with the layer positioned at a selectable interior position within the membrane.

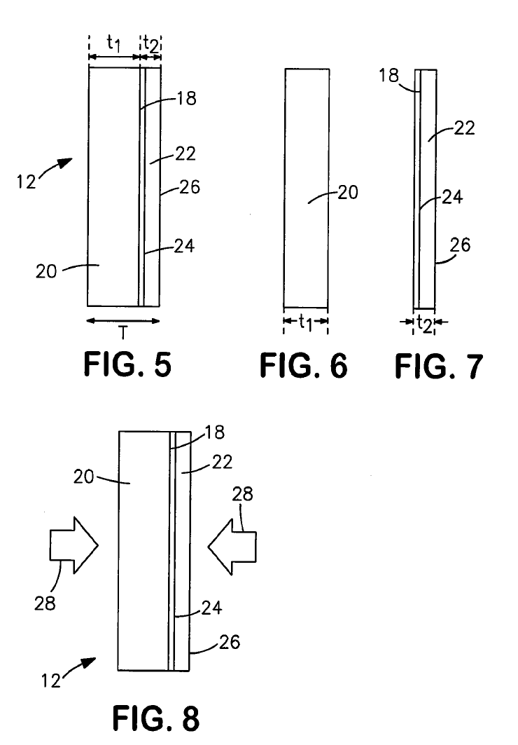

FIG. 5 schematically illustrates a portion of a membrane 12 containing layer 18 which can be a diffusion barrier layer as set forth above, or some other type of layer.

Membrane 12 has a total thickness T, and as set forth above, it is desirable to precisely position layer 18 at a particular point along the thickness T. This specific positioning of layer 18 can help to provide the layer in a location of most effectiveness, and for example can be used to position layer 18 between the cathode and the expected location of the Xo plane.

According to the invention, a membrane 12 as shown in FIG. 5 can be manufactured by providing membrane 12 as two membrane components. Examples of these two components are shown in FIGS. 6 and 7 as a cast component 20 (FIG. 6) and a reinforced component 22 (FIG. 7).

Reinforced component 22 can be a typical reinforced membrane, wherein layer 18 is positioned along one side surface 24 of a sheet of electrolyte material. Alternatively, layer 18 could be at any interior plane within component 22.

In designing membrane 12, the designer can decide the desired location for layer 18, and the respective thicknesses t1, t2 of components 20, 22 can then be determined. For example, if layer 18 is to be positioned at a location which is approximately 20% of the total thickness T of membrane 12 from one side 26 of the membrane, then component 20 can be prepared having a thickness t₁ which is 80% of the desired thickness T.

It should readily be appreciated that by laminating components 20, 22 together, as schematically illustrated by arrows 28 in FIG. 8, the resulting laminated structure has layer 18 positioned at a desired location along the total thickness T.

The component which already possesses layer 18 can be a reinforced membrane such as reinforced membranes which are provided by various MEA/UEA suppliers. Such membranes can for example have a thickness of 18 microns and can have a reinforcement along one side surface as shown in FIG. 7. In this specific example if it is desired to position layer 18 at about 40% of the membrane thickness, then component 20 can be prepared having a thickness of 25 microns. This would locate layer 18 at 43% of the thickness of membrane 12.

Alternatively, if it is desired to position layer 18 at 20% of the thickness of membrane 12, then component 22 can be obtained having layer 18 positioned at the center of the thickness t2, and/or a larger cast component 20 can be obtained. Thus, an 18 micron component 22 in this configuration would have layer 18 with approximately 9 microns of electrolyte on each side. Under these circumstances, laminating with a 25 micron cast membrane component 20 would position layer 18 approximately 9 microns from surface 26 of membrane 12, which is approximately 20% of the thickness of the membrane.

From a consideration of the above two configurations, it should be appreciated that various configurations of components 20, 22 can be appropriately selected by the manufacturer to position layer 18 as desired. These include fabricating the assembly with electrodes pre-attached to cathode and/or anode faces of resulting assembly 12/28.

Control of thickness t1 of component 20 is one relatively convenient way to control the exact position of layer 18. Component 20 can be cast having a desired thickness, and is therefore a very versatile component of the present disclosure. Of course, other methods of manufacture can be utilized to provide component 20 as desired. It should also be appreciated that the lamination of two or more components together helps to insure that any pre-existing manufacturing defects in any of the components do not and will not propagate through much of the membrane thickness. This greatly reduces the possibility of a defect or crack propagating through the entire thickness of the membrane.

The above manufacturing process is described in terms of manufacturing a membrane having layer 18 which in this instance is a reinforcement layer that serves as a diffusion barrier. It should of course be appreciated that the same manufacturing procedure can be applied to other types of membrane manufacture having different types of layers which are to be internally positioned at precise locations within the thickness of the membrane, and that such manufacture is well within the broad scope of the present disclosure.

While the present disclosure has been described in the context of specific embodiments thereof, other alternatives, modifications, and variations will become apparent to those skilled in the art having read the foregoing description. Accordingly, it is intended to embrace those alternatives, modifications, and variations as fall within the broad scope of the appended claims.

What is claimed:

1. A membrane electrode assembly, comprising:
an anode;
a cathode;
a membrane between the anode and the cathode and having a thickness defined between the anode and the cathode; and
a catalyst diffusion barrier layer in a location bounded on one side by an interface between the membrane and the cathode, and bounded on the other side by a plane approximately 50% of the thickness of the membrane from the cathode.

2. The assembly of claim 1, wherein the barrier layer comprises a web structure impregnated with ionomer.

3. The assembly of claim 1, wherein the cathode contains a platinum catalyst, and wherein the barrier layer inhibits migration of soluble platinum from the cathode past the barrier layer.

4. The assembly of claim 3, wherein the barrier layer comprises an ePTFE layer.

5. The assembly of claim 1, wherein the barrier layer is a separate layer between the membrane and the cathode 16, and wherein the barrier layer has a thickness of between about 1 micron and about 15 microns.

6. The assembly of claim 1, wherein the barrier layer is positioned within the membrane 12, and wherein the barrier layer has a thickness which is between about 25% and about 33% of the total membrane thickness.

7. A method for mitigating decay of a membrane electrode assembly, comprising operating a membrane electrode assembly having an anode, a cathode, a membrane between the anode and the cathode, and a catalyst diffusion barrier layer in a location bounded on one side by an interface between the membrane and the cathode, and bounded on the other side by a plane approximately 50% of the thickness of the membrane from the cathode so that the catalyst diffusion barrier layer is between the cathode and a plane of potential change between the anode and the cathode.

8. The method of claim 7, wherein the barrier layer comprises a web structure impregnated with ionomer.

9. The method of claim 7, wherein the cathode contains a platinum catalyst, and wherein the barrier layer inhibits migration of soluble platinum from the cathode past the barrier layer.

10. The method of claim 9, wherein the barrier layer comprises an ePTFE layer.

11. A method for manufacturing a membrane having a desired total thickness, and containing a layer at a desired location within the desired total thickness, comprising the steps of:
providing a first membrane component having a first thickness less than the desired total thickness and containing the layer;
providing a second membrane component having a second thickness less than the desired total thickness; and
laminating the first membrane to the second membrane.

12. The method of claim 11, wherein the layer comprises a catalyst diffusion barrier layer.

13. The method of claim 11, wherein the first membrane has a layer on one side.

14. The method of claim 11, wherein the second membrane is provided by casting a membrane having the second thickness.

15. The method of claim 11, where electrodes are pre-attached to one or both of the membrane components.
